(19) United States
(12) Patent Application Publication
(10) Pub. No.: US 2008/0033599 A1
(43) Pub. Date: Feb. 7, 2008

(54) Method and system for controlling heating ventilation and air conditioning (HVAC) units

(76) Inventors: Rouzbeh Aminpour, Irvine, CA (US); Marc Gaddis, Long Beach, CA (US)

Correspondence Address: Myers Dawes Andras & Sherman LLP, Suite 1150, 19900 MacArthur Blvd., Irvine, CA, 92612, US

(21) Appl. No.: 11/497,748

(22) Filed: Aug. 2, 2006

(51) Int. Cl. G01M 1/38; G05B 13/00; G05B 11/01

(52) U.S. Cl. 700/276; 700/17

(57) ABSTRACT

An HVAC control system provides a central controller that controls registers/vents which capture energy of air flowing in the duct system and convert it to an electrical current that is stored locally in energy storage units in the register/vent. Further, wireless communication between the central controller and the register/vents alleviates the need for wire runs and maintenance. Use of unique register identifiers allows the central controller to individually control each register based on user settings. As such, the user can install one or more registers and individually control one or more registers for desired temperature control in each zone. A wireless network allows user interaction with the central controller via a Web-page utilizing a Web browser on a PC that wirelessly connects to the central controller (e.g., via a wireless network). The register/vent combination is preferably and all-in-one unit that slides into the air duct opening in each zone.

### FIELD OF THE INVENTION

The present invention relates to HVAC control mechanisms; and in particular to an interactive group of functions that allow a user to interact with and control HVAC unit.

### BACKGROUND OF THE INVENTION

HVAC units are utilized in various capacities for the heating and cooling of areas inside the buildings. The standard for conventional HVAC units is to place a thermostat in one of the rooms within the building. The thermostat determines the room temperature at its physical location and determines whether the room temperature is below or above a user's requirements. However, various rooms in a building, and especially those on different floors, may have large temperature differentials. Therefore, it is common that a thermostat placed in a room of one floor cannot detect increasing heat accumulating in another area or floor in the building. The reverse is also common. This leads to inadequate and/or inappropriate cooling for different locations in the building. Additionally, such units are not energy efficient and lack user control.

As such, a variety of temperature zoning devices have been devised to address the above shortcomings. However, such zoning devices are complex, expensive and very labor intensive to install properly. Certain systems require installation of air tubing throughout the duct system that in turn inflate an airbag, for example, to block air from flowing to various rooms of the building. Other systems require replacing sections of an existing duct unit with a zoning duct that has a shutter/damper installed. These shutters/dampers require electrical connections by licensed professionals. Further, such systems do not allow the ability to monitor heating and cooling requirements via graphical user interfaces locally or remotely such as Internet-based (e.g., Web-based) interfaces.

### BRIEF SUMMARY OF THE INVENTION

The present invention provides an HVAC control method and system including a central controller that controls energy storage unit operated registers/vents. Each register/vent captures energy of air flowing in the duct system and converts to an electrical current that is stored locally in a energy storage unit in the register/vent. Further, wireless communication between the central controller and the register/vents alleviates the need for wire runs and professional installation. Use of unique register identifiers allows the central controller to individually control each register based on user settings. As such, the user can install one or more registers and individually control one or more registers for desired temperature control in each zone. Preferably, the user can control each register for desired temperature control in a zone.

A wireless network, such as an IEEE802.11x-based network, allows user interaction with the central controller via a user interface such a Web-based interface utilizing a Web browser on a control device such a portable or desktop computer. Such a control device wirelessly connects to the central controller via a wireless connection. The register/vent combination is preferably an all-in-one unit that slides into the air duct opening in each zone.

In one aspect, a control system is provided for controlling an HVAC unit. The system comprises a central controller connected to the HVAC unit for controlling the HVAC settings. The central controller comprises a wireless communication interface including a first wireless transceiver for wireless communication with a display device capable of displaying a user interface for user interaction with the central controller via the user interface to control the HVAC settings.

The central controller further maintains a control user interface therein, and provides the control user interface device to the display device for display to the user. The control user interface may comprise a Web-page user interface, and the display device may include a Web browser capable of displaying the Web-page. The central controller controls the HVAC unit based on user commands through the user interface.

The wireless communication interface comprises a wireless transceiver. The wireless transceiver may comprise an IEEE802.11x transceiver.

The control system further comprises one or more vent controllers. Each vent controller controls operation of a corresponding air vent that receives air flow from the HVAC unit via an air duct. The wireless communication interface further includes a second wireless transceiver for communication with each vent controller. Each vent controller includes a wireless transceiver for wireless data and/or command communication between the vent controller and the central controller.

Each vent controller controls an actuator for operating a corresponding air vent based on commands from the central controller. Each vent controller further includes a temperature sensor for sensing the ambient temperature and communicating the sensed temperature to the central controller. Each vent controller may further include a power generation unit that powers the vent controller.

The power generation unit may comprise a rechargeable energy storage unit. The power generation unit may further include a power generator for supplying power to the vent controller and charging the energy storage unit. The power generator in each vent controller may convert either air flow energy or light proximate the vent into electrical power.

In another aspect, a control system for controlling an HVAC unit comprises a central controller connected to the HVAC unit for controlling the HVAC settings. The central controller includes a wireless communication interface for wireless communication with a display device capable of displaying a user interface for user interacting with the central controller via the user interface to control the HVAC settings. One or more vent controllers may be provided. Each vent controller controls operation of a corresponding air vent that receives air flow from the HVAC unit via an air duct. The central controller further maintains a control user interface therein, and provides the control user interface device to the display device for display to the user.

The control user interface may comprise a Web-page user interface while the display device may include a Web browser capable of displaying the Web-page. The central controller controls the HVAC unit based on user commands through the user interface. The wireless communication interface of the central further provides communication with each vent controller. Each vent controller includes a wireless transceiver for wireless data and/or command communication between the vent controller and the central controller.

Each vent controller controls an actuator for operating a corresponding air vent base on commands from the central controller. Each vent controller further includes a temperature sensor for sensing the ambient temperature and communicating the sensed temperature to the central controller. Each vent controller may further include a power generation unit that power the vent controller.

Each power generation unit comprises a rechargeable energy storage unit. Each power generation unit may further include a power generator for supplying power to the vent controller and charging the energy storage unit.

Each power generator in each vent controller converts light or air flow energy proximate the vent into electrical power. Each vent controller includes an identifier which uniquely identifies the vent controller to the central controller for command and control.

In a further aspect, a control system for controlling an HVAC unit comprises a master vent controller connected to the HVAC unit for controlling the HVAC settings. The master vent controller includes a wireless communication interface for wireless communication with a display device capable of displaying a user interface for user interacting with the master vent controller via the user interface to control the HVAC settings. The master vent controller further controls operation of a corresponding air vent that receives air flow from the HVAC unit via an air duct. One or more vent controllers are provided, wherein each vent controller controls operation of a corresponding air vent that receives air flow from the HVAC unit via an air duct. The master vent controller further maintains a control user interface therein, and provides the control user interface device to the display device for display to the user.

The control user interface preferably comprises a Web-page user interface while the display device preferably includes a Web browser capable of displaying the Web-page. The master vent controller controls the HVAC unit based on user commands through the user interface. The wireless communication interface of the master vent further provides communication with each vent controller. Each vent controller includes a wireless transceiver for wireless data and/or command communication between the vent controller and the master vent controller.

The master vent controller controls an actuator for operating a corresponding air vent. Each vent controller controls an actuator for operating a corresponding air vent base on commands from the master vent controller. The master vent controller further includes a temperature sensor for sensing the ambient temperature. Each vent controller further includes a temperature sensor for sensing the ambient temperature and communicating the sensed temperature to the central controller.

The master vent controller further includes a power generation unit that powers the corresponding vent controller. Each vent controller further includes a power generation unit that powers the corresponding vent controller. Each power generation unit comprises a rechargeable energy storage unit. Each power generation unit further includes a power generator for supplying power to the vent controller and charging the energy storage unit. Each power generator in each vent controller converts either light or air flow energy proximate the vent into electrical power.

Each of the master controller and the vent controllers includes an identifier which uniquely identifies the vent controllers each other for command and control.

These and other features, aspects and advantages of the present invention will become understood with reference to the following description, appended claims and accompanying figures.

### BRIEF DESCRIPTION OF THE DRAWINGS

FIG. 1 shows a block diagram of an HVAC system including an HVAC unit and a wireless control system implementing a method of controlling the HVAC unit, according to an embodiment of the present invention.

FIG. 2 shows a functional block diagram of the control system in FIG. 1 including a central controller and multiple individual vent controllers (registers), according to an embodiment of the present invention.

FIG. 3 shows a flowchart of steps of an HVAC control method implemented by the central controller of the control system of FIG. 2, according to an embodiment of the present invention.

FIG. 4 shows a flowchart of the steps of HVAC control method implemented in each individual vent controller (register) of FIG. 2, according to an embodiment of the present invention.

FIG. 5 shows a block diagram of an HVAC system including a master register implementing a method of controlling an HVAC unit, according to a further preferred embodiment of the present invention.

FIG. 6 shows a flowchart of steps of an HVAC control method implemented by the master register of FIG. 5, according to a further preferred embodiment of the present invention.

FIG. 7 shows a flowchart of the steps of HVAC control method implemented in each individual register (other than master register), according to a further preferred embodiment of the present invention.

### DETAILED DESCRIPTION OF THE PREFERRED EMBODIMENTS

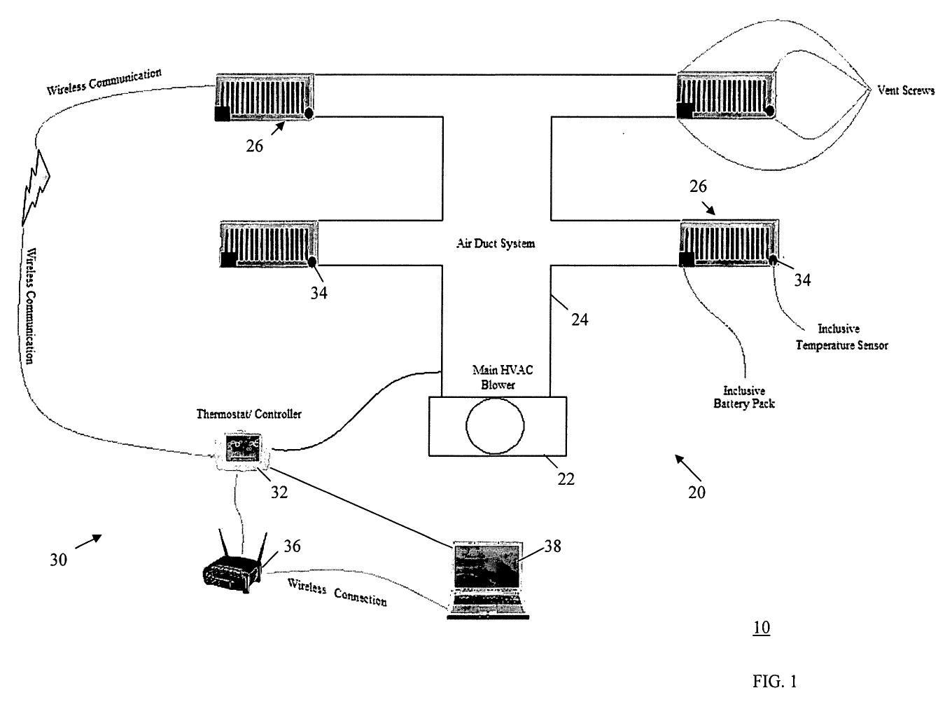

The present invention provides preferred methods and apparatuses for control of HVAC units. In one preferred embodiment, the present invention utilizes wireless communication technology for communicating between a control system with a central temperature controller, and distributed individual vent controllers for automated vents of an HVAC unit. FIG. 1 shows a block diagram of an HVAC system 10 including an HVAC unit 20 and a wireless control system 30, implementing a method of controlling the HVAC unit 20, according to a preferred embodiment of the present invention.

The HVAC unit 20 includes a blower 22 and air ducts 24 which deliver forced air from the blower 22 to multiple air vents 26. The control system 30 includes a central controller 32 that communicates with individual vent controllers 34 via wireless communication (e.g., X10 wireless transceiver). In this example, the individual vent controllers 34 are shown connected to the vents 26.

Preferably, the control system 30 is self-contained and provides its entire power requirements, thereby freeing the vents 26 from requiring either electrical wiring or air tubing. The central controller 32 will preferably replace existing controllers that have wiring in place (e.g., 120 VAC). Further, preferably the individual vent controller 34 for each vent 26 in a room may comprise an inclusive temperature sensor with a zoning register that allows the central controller 32 to monitor/control the temperature within each room separately via the wireless communication channel. In one example, an identification-based method provides users the ability to install, and individually identify and control, several zoning registers. The registers are preferably distributed in different zones around the building in order to achieve zoned cooling/heating in the building as desired.

A user interface is provided that simplifies user interaction with the control system 30. As shown in FIG. 1, the control system 30 further includes a display device 38 (e.g., PC) that can be used for the user interface. In one example, the control system 30 provides a Web-based user interface that provides users with the ability to easily control and monitor heating and cooling requirements. The user interface provides critical information and enables users to optimize operations of their HVAC unit 20 for greater efficiency. The control system 30 further provides reports (e.g., through the user interface), that can be compiled by the users for analysis.

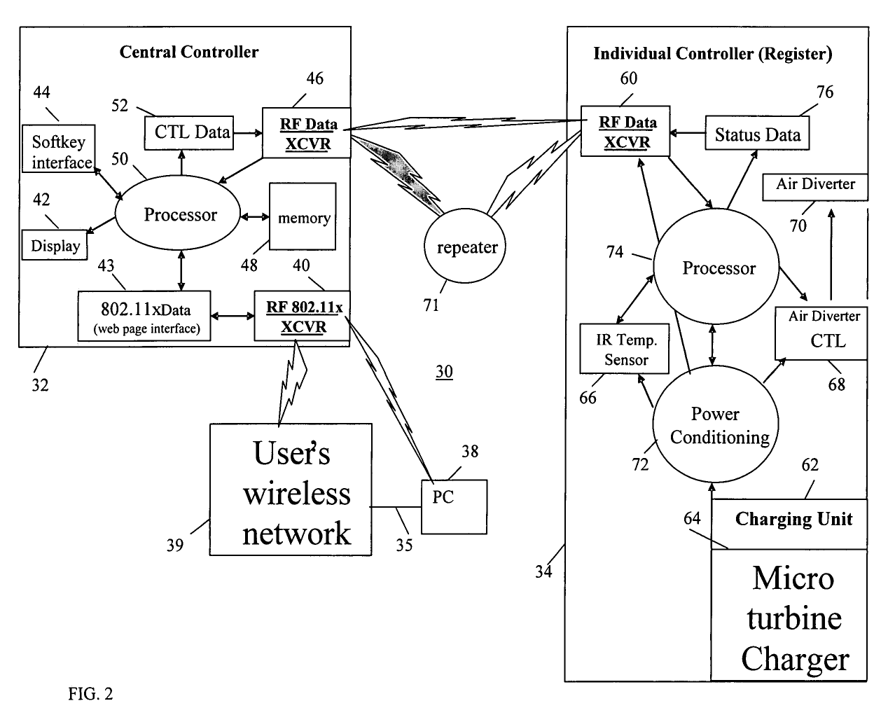

An example implementation of the components of the control system 30, in conjunction with the HVAC unit 20, is described below. FIG. 2 shows a functional block diagram of an implementation of the control system 30, including the central controller 32 and an individual vent controller implemented as a register 34, according to an embodiment of the present invention. Even though FIG. 2 only shows one individual vent controller as register 34, those skilled in the art recognize that each of the multiple individual vent controllers of the control system 30 in FIG. 1 can be implemented as the register 34 shown in FIG. 2. The user can scale the control system 30 according to need by selecting the number of registers 34 for the desired number of zones in a building.

A user can utilize a personal computer (PC) 38 to display a Web-based interface according to the present invention in order to interact with the control system 30. Throughout this specification, the terms “computer,” “personal computer” and “PC” may be used interchangeably to refer to all types of computers and control devices, including, but not limited to, Macintosh computers, notebook or laptop computers, handhelds, etc. In this example, the PC 38 connects to a user's wireless network 39 via a wireless communication link 35. The wireless network 39 or the user's wireless card within PC 38 are implemented via either the use of the router 36 (FIG. 1) or direct communication to the wireless communication capabilities of the central controller 32. The wireless network 39 provides a TCP/IP network that allows a user to utilize the PC 38 to connect to the network 39 via the communication link 35 (e.g., WLAN connection or remotely via the Internet), and interact with the central controller 32 for command/control of the register 34. Allowing remote access to the central controller 32 provides users with the ability to remotely turn on/off/adjust their air-conditioning/heating as well as analyze historical temperature statistics via an embedded analytical software tool. In one embodiment, the analytical software is embedded in the controller 32.

The central controller 32 includes a wireless communication interface that includes a first wireless transceiver 40 that allows wireless communication between the central controller 32, and the wireless network 39 and/or the PC 38 directly. This allows a user to utilize said Web-page displayed by the PC 38 to wireless communicate with the central controller 32.

The central controller 32 itself may include a display 42 and a key input interface 44 on a front panel thereof that provides the same functionality as the Web-page. The display 42 can comprise a single color/full color screen that may either be touch screen or include soft-keys 44.

The central controller 32 includes the functionality of a thermostat, and the transceiver 40 provides the ability to wirelessly set temperature profiles according to user commands, described in more detail further below.

The first transceiver 40 comprises a wireless modem that enables the controller 32 to communicate with the user's wireless card in the PC 38, modem or router 36 (FIG. 1) of the wireless network 39. The transceiver 40 enables a user to login to the central controller 32 via the wireless unit 36 or modem, e.g. implementing an IEEE 802.11x protocol. As used throughout the specification, the “x” in 802.11x is generic and may comprise all letters, such as a, b, c, d and so forth. Local users only need a wireless modem to connect in order to communicate with the transceiver 40 of the central controller 32. This feature allows multiple users to access the central controller 32 from any location within a building where the central controller 32 is installed in order to monitor and change various temperature/zoning settings. Users may login to the central controller 32 from PCs and the like. For example, employees of a company located in multiple offices in a building can login to the central controller 32, wherein each employee can change the temperature setting for his office without the need to physically go to the controller.

The central controller 32 includes user interface data 43, including a Web-page interface, that is displayed every time a user logs onto to the user account on the central controller 32. Individual user accounts and settings for each register 34 are stored in a database in the storage device 48.

The central controller 32 further includes a processor 50 that executes program instructions which implement a preferred method of the present invention, as described herein. The processor 50 can comprise a single or multiple microprocessors. The processor 50 interfaces with all other components of the system controller 32, and determines timing for all internal processes coding, communication and messages sent back and forth, display settings and various menus available to the user. Additionally, the processor 50 provides control data and commands to each register 34 via a control data unit 52. The control data unit 52 (e.g., memory or a data register) functions as a buffer between the processor 50 and the transceiver 46. The control data unit 52 receives data from either the register 34 or the controller processor 50, and maintains the received data until utilized. The processor 50 controls and manages all the functionality of the central controller 32.

Said wireless communication interface of the central controller 32 further includes a second wireless transceiver 46 for wireless communication with the register 34. Though in FIG. 2 the transceivers 40 and 46 are shown as separate logical units, those skilled in the art will recognize that the transceivers 40 and 46 can be component of a single wireless communication interface.

The register 34 provides temperature measurement, data communication, charging and airflow control through a corresponding vent 26. The register 34 includes a vent wireless transceiver 60 for wireless communication with the central controller 32 via the wireless communication interface of the central controller 32. The vent transceiver 60 allows the register 34 to send messages to, and receive commands from, the central controller 32. Each register 34 is assigned a unique serial number that is used by the central controller 32 to identify each register 34 during communication. Preferably, the transceiver 60 is coded with a unique identification number that distinguishes it from any other register.

The register 34 further includes a temperature sensor 66 (e.g., infrared temperature sensor) to detect the temperature in a zone where the register 34 is positioned. In one example, the register 34 commands a small actuator/driver 68 to operate air diverters, or air directors, (e.g., vent shutters) 70 when instructed by the system controller 32. Preferably, each register 34 is connected to the face plate of the corresponding vent 26, which can easily slide into an air duct (FIG. 1) with the temperature sensor 66 exposed in order to sense ambient temperature. As such, the register-vent combination is consumer friendly with easy installation and minimum maintenance requirements.

The temperature sensor 66 takes temperature readings on a scheduled time frame under control of a register processor 74. Additionally, a secondary internal temperature sensor (non-infrared) can take readings of incoming air temperature. The temperature measurements are sent back from the register 34 to the central controller 32 via the RF Data Transceivers 46, 60.

Preferably, the register 34 is powered by a self-contained power generation system that includes a energy storage unit 62, such as one or more batteries or capacitors, that can be recharged using a power generator 64 that converts light and/or air flow energy into electrical power. Accordingly, the power generator 64 may comprise a solar charging device or a turbine charger that has one or more wind turbines (mini or standard) and/or fans. The air is accelerated through convergent ductwork to ensure sufficient airflow to spin the wind turbines/fans of the charger 64. When a vent 26 corresponding to a register 34 is closed, the air still flows through the wind turbines/fans of the generator 64 for charging and it is directed back into the vent 26.

Preferably, the energy storage unit 62 is used as storage for excess power generated by the generator 64. The energy storage unit 62 may be accessible to the user via an opening in the front of the vent 26. Additionally, the energy storage unit 62 is designed to meet the power requirements of the register 34 when the generator 64 is not generating sufficient voltage for the register 34.

A power conditioning unit 72 in the register 34 is placed between the processor 74 and the charging/energy storage unit 62. The power conditioning unit 72 distributes the proper amount of electrical power (e.g., voltage) to each electrical component within the register 34. This power conditioning unit 72 essentially serves as a power regulation device for the register 34. Additionally, the power conditioning unit 72 prevents power surges or drops from damaging the register 34.

The register 34 further includes a status data unit 76 that buffers data transfer between the processor 74 and the transceiver 60, much the same way as the transceiver 46 in the controller 32 does. Additionally, the status data unit 76 compiles unit statistics (e.g., data including inlet/outlet temperature, on/off time and failures, etc.) as well as temperature output levels, and sends them to the central controller 32 via the RF data transceivers 60, 46.

The processor 74 in the register 34 functions in a similar fashion to the processor 50 in the central controller 32, except that the processor 74 is in charge of the register 34 components. The processor 74 may include one or more microprocessors, and has the overall responsibility to monitor, and directly command, the various components (e.g., temperature sensor 66, air diverter control 68, etc.) of the control system 30. Additionally, the processor 74 monitors the power level and charging status of the energy storage unit 62.

The vent air diverters 70, such as shutters, implement a valve system that directs air into a room, or turns to a closed mode thereby circulating the air back into the vent. This method allows the register 34 to increase airflow management. The air diverter controller 68 monitors the position of the air diverters 70 and provides feedback to the processor 74. The controller 68 turns the air diverters 70 open/closed upon receiving commands from the processor 74. The air diverter controller 68 includes a driver with sufficient torque to turn the air diverter pieces.

In some instances, the airflow within a vent may not be sufficient for the generator 64 to generate adequate electricity to meet the power requirements of the register 34. As such, air flowing through the vent is condensed via a converging duct system that in turn spins the power generation unit 64 faster. This increases power output and power storage capabilities. The converging duct feeds the fan, and then disperses quickly to slow down the velocity of the condensed air.

As noted, the central controller 32 communicates via a wireless channel with each register 34. The control system 30 can optionally utilize a repeater 71 as necessary if low RF signal strength prevents the system controller 32 from properly communicating with one or more registers 34. The repeater 71 can essentially comprise a transceiver.

In the preferred embodiment, the user installs and interacts with the system 10 as follows. The user purchases a minimum of one system control 30 including the central controller 32 and register 34. The controller 32 is connected to the register 34, wherein the controller 32 communicates with the register 34 and automatically recognizes the register 34 via the unique identification of the register 34. The controller 32 then asks the user (via user interface), for the user to name the connected register 34. The user names the register 34 causing the controller 32 to assign that name as a unique name to the internal identifier (e.g., serial number) for the register 34. Thereafter, any commands pertaining to the specified name link the controller 32 and that specific register 34 together. The user disconnects the register 34 from the controller 32, and repeats the process for each additional register 34. The registers 34 and corresponding vents are installed in different zones in the building.

Register installations are designed with consumer friendliness in mind. The central controller 32 is also connected to the HVAC unit 20. The central controller 32 then automatically turns on the blower 22 (FIG. 1) to provide the newly installed registers 34 with sufficient air current to charge their power generation units/energy storage units. A user who wishes to utilize his PC to monitor the central controller 32 can do so by searching for available network connections and then connect to the controller 32. Once connected, the Web-page user interface from the controller 32 website is provided to the user PC to monitor and change settings to the control system 32.

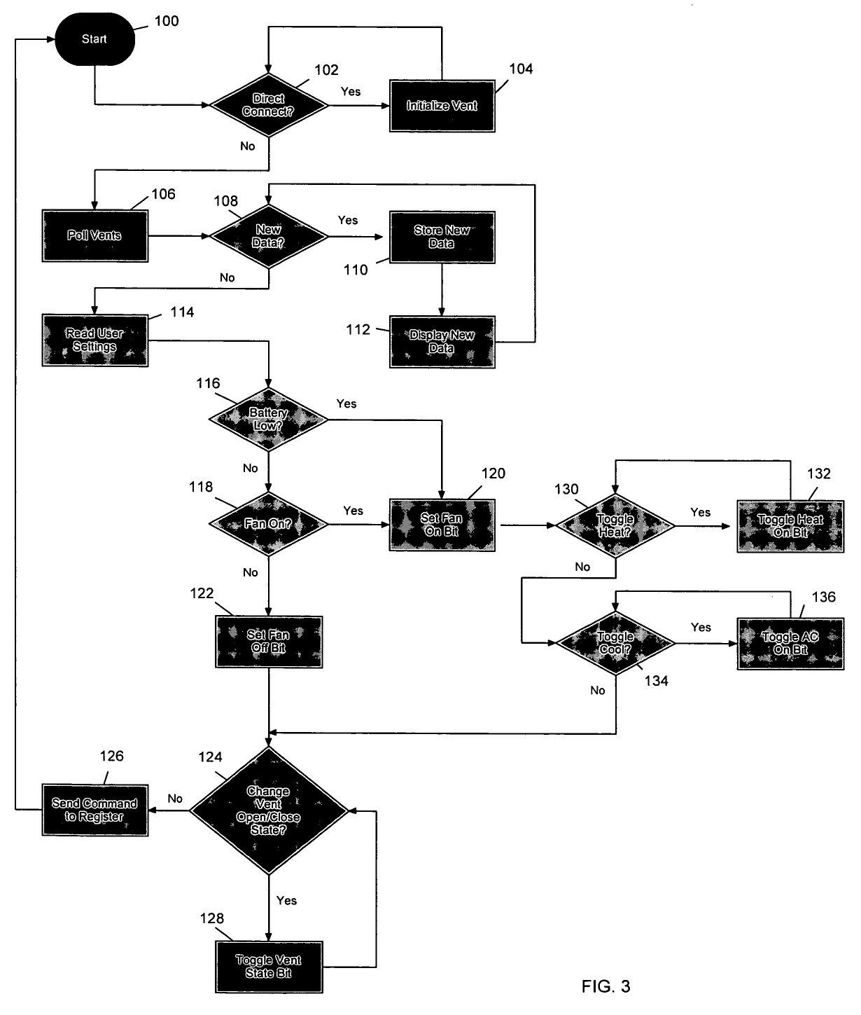

FIG. 3 shows a flowchart of steps of an HVAC control method implemented by the central controller 32, according to a preferred embodiment of the present invention, including the steps of:
Step 100: Start.
Step 102: Determine Direct Connection to the register/vent 34 for initialization of the installation If yes, go to step 104, otherwise go to step 106.
Step 104: Initialize vent register 34.
Step 106: Poll the registers 34 in the vents.
Step 108: Determine if any register 34 has new data to provide? If so, go to step 110, otherwise go to step 114.
Step 110: Receive data from each register 34 that has new data and store the new data in data storage device 48 (e.g., memory, disk drive, etc).
Step 112: Display the new data to the user, go back to step 108.
Step 114: Read user settings for each register 34 from the storage device 48.
Step 116: Determine if the energy storage unit power for a register is low? If not, go to step 118, otherwise go to step 120.
Step 118: Determine if the HVAC blower fan is on? If not, go to step 122, otherwise go to step 120.
Step 120: Turn the HVAC blower fan on, and go to step 130.
Step 122: Turn HVAC blower fan off.
Step 124: Determine if vent air diverter state needs change based on whether the associated room needs to be heated or cooled. If not, got to step 126, otherwise go to step 128.
Step 126: Send command to register in order to open/close or activate motor. Go back to step 100.
Step 128: Toggle the vent state bit to change state of the blower fan. Go back to step 124.
Step 130: Determine if heating state needs change based on the temperature setting versus the actual temperature. If yes, go to step 132, otherwise, go to step 134.
Step 132: Change heating status by toggle. Go back to step 130.
Step 134: Determine if cooling state needs change based on the temperature setting versus the actual temperature. If yes, go to step 136, otherwise, go to steps 124.
Step 136: Change cooling status by toggle. Go back to step 134.

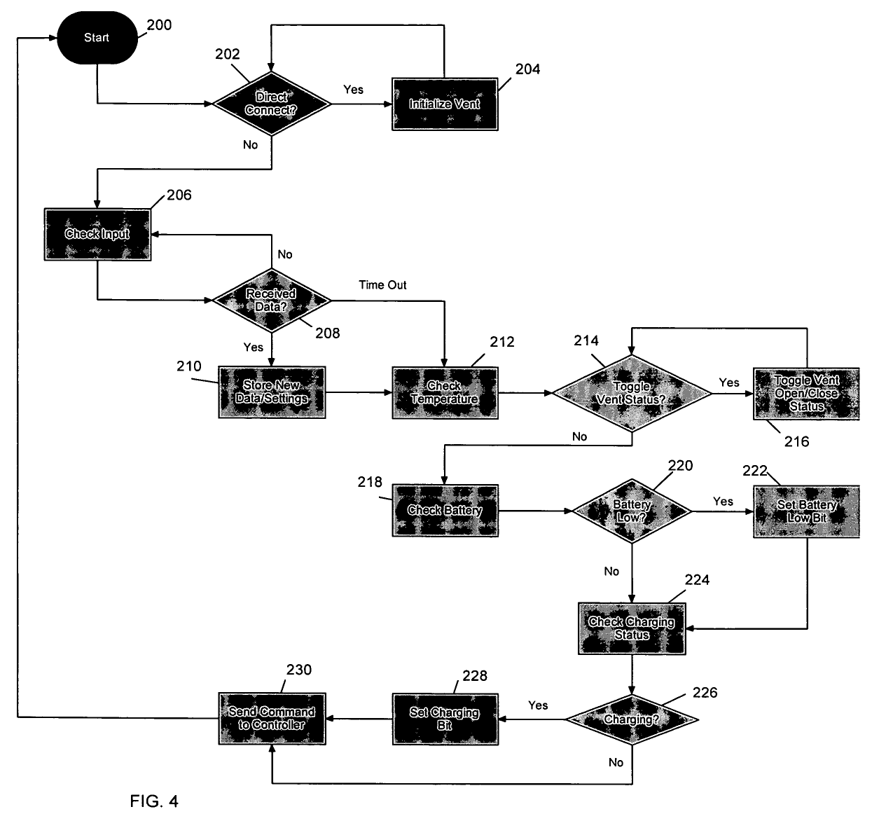

FIG. 4 shows a flowchart of the steps of a preferred HVAC control method implemented by each register 34 of FIG. 2, according to an embodiment of the present invention.
Step 200: Start.
Step 202: Determine Direct Connection to the controller for initialization. If yes, go to step 204, otherwise go to step 206.
Step 204: Initialize vent register 34.
Step 206: Check for input from central controller 32.
Step 208: Received data from controller 32? If not, go back to step 206, otherwise go to step 210. If timed out on receiving data from the central controller 32, then go to step 212.
Step 210: Store new data/settings in memory/processor from the central controller 32. Go to step 212.
Step 212: Check temperature via temperature sensor 66.
Step 214: Determine if change in vent state is needed (for zone cooling/heating) based on the temperature and/or the new data settings? If yes, go to step 216, otherwise go to step 218.
Step 216: Change (toggle open/close) vent state. Go back to step 214.
Step 218: Check energy storage unit status.
Step 220: Determine if energy storage unit status is low. If yes, go to step 222, otherwise go to step 224.
Step 222: Set energy storage unit low bit to start charging energy storage unit.
Step 224: Check charging status of the energy storage unit.
Step 226: Determine if the energy storage unit is charging? If not, go to step 230, otherwise go to step 228.
Step 228: Set charging bit
Step 230: Send command to central controller 32. Go back to step 200.

As such, an HVAC control method and system according to a preferred embodiment of the present invention provides a central controller that controls registers/vents operated by energy storage units. Each register/vent captures energy of air flowing in the duct system and converts to an electrical current that is stored locally in an energy storage unit in the register/vent. Further, wireless communication between the central controller and the register/vents alleviates the need for wire runs and professional installation. Use of unique register identifiers allows the central controller to individually control each register based on user settings. As such, the user can install one or more registers and individually control one or more registers, and preferably each register, for desired temperature control in each zone. The IEEE802.11x-based network allows user interaction with the central controller via a Web-page utilizing a Web browser on a PC that wirelessly connects to the central controller (e.g., via a wireless home network). The register/vent combination is preferably and all-in-one unit that slides into the air duct opening in each zone.

Further, the central controller 32 can function autonomously even without any active registers 34. This allows installation of the central controller 32 to function as a digital thermostat that controls the HVAC unit blower and condenser (not vents), as well as take advantage of Web-based monitoring services of the thermostat function.

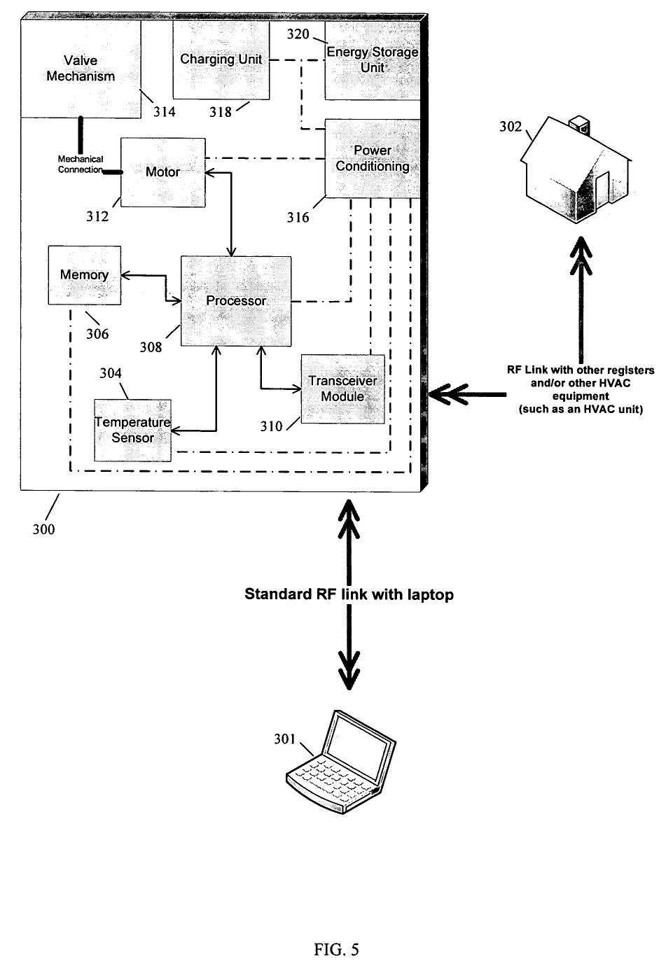

Referring to the example block diagram in FIG. 5, according to another preferred embodiment of the present invention, the functionality of the central controller 32 above is implemented in a master register 300 as shown in FIG. 5. The registers 34 remain as described above in connection with FIGS. 1-4. As such, the central controller 32 in FIGS. 1-4 may be optional. The master register 300 includes wireless communication capabilities for communicating with a control device such as a portable computer 301. A user utilizes a user interface displayed by the computer 301 to interact with the master register 300. As described above, the master register 300 may include an embedded user interface that it provides to the computer 301 for display and user interaction. Based on user commands, the master register 300 then communicates with other registers and/or HVAC equipment for temperature control.

In this example, the master register 300 comprises a temperature sensor 304, memory/storage device 306, a processor 308, a transceiver 310, a motor 312 for driving vent valve mechanism 314, power conditioning module 316, a charging unit 318 and an energy storage unit 320.

In the example register 300 of FIG. 5, the temperature sensor 304, processor 308, motor 312, valve mechanism 314, power conditioning module 316, charging unit 318 and energy storage unit 320, can be similar to the temperature sensor 66, processor 74, air diverter controller 68, air diverter 70, power conditioning 72, charger 64 and energy storage 62, respectively, of other registers 34 as in FIG. 2, described above. The memory/storage device 306 and transceiver 310 of the master register 300 can be similar to the memory 48 and the wireless communication interface (combined transceivers 40, 46), respectively, of the central controller 32 of FIG. 2, described above.

In addition to controlling the valve mechanism corresponding to the master register 300, the master register 300 commands and controls other registers 34, much like the central controller 32 above.

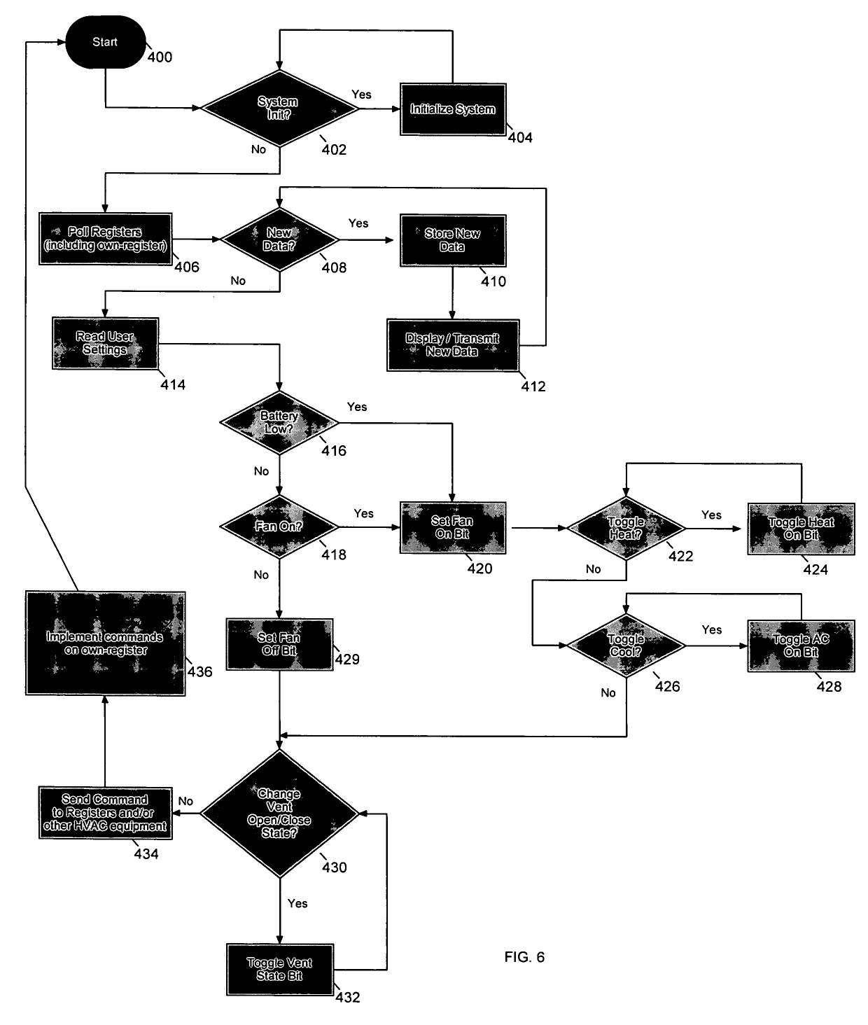

FIG. 6 shows a flowchart of steps of an HVAC control method implemented by the master register 300 of FIG. 5, according to a further preferred embodiment of the present invention, including the steps of:
Step 400: Start.
Step 402: Determine if register system initialization is necessary? If yes, go to step 404, otherwise go to step 406.
Step 404: Initialize register system. Go to step 402.
Step 406: Poll all registers including master register for new data.
Step 408: Determine if any register has obtained new data/commands from the controller. If yes, got to step 410, otherwise go to step 414.
Step 410: Obtain new data from register(s) and store e.g. in storage 306.
Step 412: Display and/or transmit new data to a display device for the user to see. Go to step 408.
Step 414: Read user settings from memory storage 306.
Step 416: Determine if the master register storage unit is low. If not, then go to step 418, otherwise go to step 422.
Step 418: Determine if the master register has fan on. If yes, go to step 420, otherwise, go to step 429.
Step 420: Set fan on bit.
Step 422: Toggle heating based on user settings If yes, go to step 424, otherwise go to step 426.
Step 424: Toggle “heat on” bit. Go to step 422.
Step 426: Toggle cooling based on user settings? If yes, go to step 428, otherwise go to step 430.
Step 428: Toggle cooling on” bit. Go to step 426.
Step 429: Set “fan on” bit.
Step 430: Change vent open/close state? If yes, go to step 432, otherwise, go to step 434.
Step 432: Toggle vent state bit. Go to step 430.
Step 434: Send command to registers and/or HVAC unit.
Step 436: Implement commands to open/close on the master register as well. Go to step 400.

The master register 300 performs all of the steps that other registers 34 perform (except transmit data), when it polls the other registers. The processor 308 of the master register 300 implements the steps in the flowchart of FIG. 6.

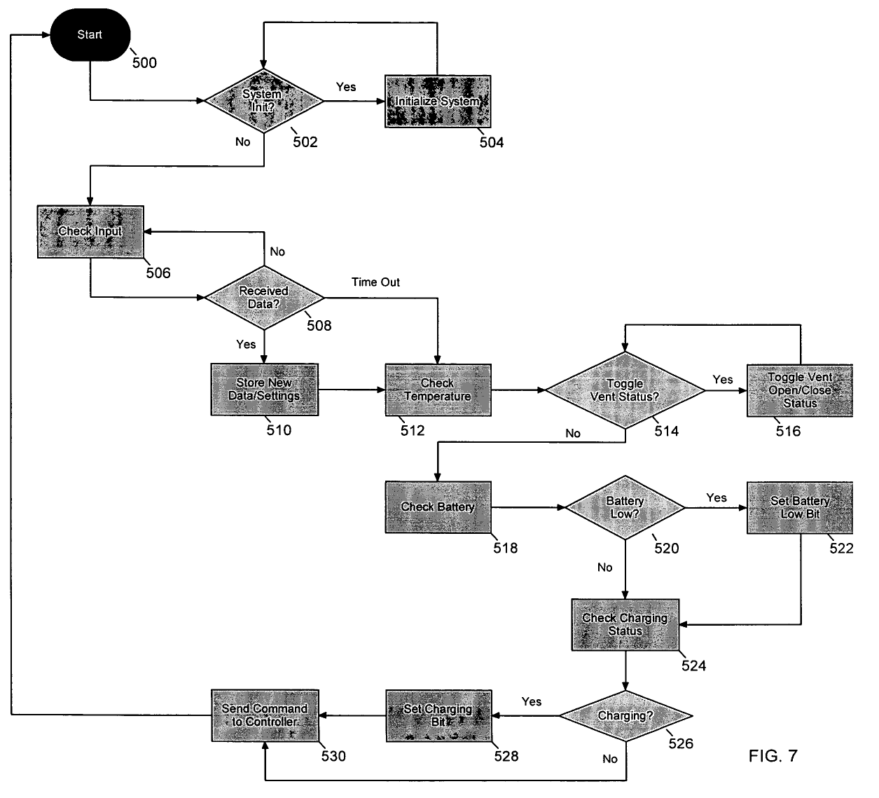

FIG. 7 shows a flowchart 500 of the steps of HVAC control method implemented in each individual register 34 (other than master register 300), according to a further preferred embodiment of the present invention, including the steps of:
Step 500: Start.
Step 502: Determine if register system initialization is necessary? If yes, go to step 504, otherwise go to step 506.
Step 504: Initialize register system. Go to step 502.
Step 506: Check for input from the master register 300.
Step 508: Received data from master register 300? If not, go back to step 506, otherwise go to step 510. If timed out on receiving data from the master register 300, then go to step 512.
Step 510: Store new data/settings in memory/processor. Go to step 512.
Step 512: Check temperature via temperature sensor.
Step 514: Determine if change in vent state is needed (for zone cooling/heating) based on the temperature and/or the new data settings? If yes, go to step 516, otherwise go to step 518.
Step 516: Change (toggle open/close) vent state. Go back to step 514.
Step 518: Check energy storage unit status.
Step 520: Determine if energy storage unit status is low. If yes, go to step 522, otherwise go to step 524.
Step 522: Set energy storage unit low bit to start charging energy storage unit.
Step 524: Check charging status of the energy storage unit.
Step 526: Determine if the energy storage unit is charging? If not, go to step 530, otherwise go to step 528.
Step 528: Set charging bit.
Step 530: Send command to master register 300. Go back to step 500.

In one example, all of the registers are made the same way, wherein one of the registers functions as the master register 300 based on programming. The master register 300 can be selected amongst all the registers 34 by a discrete (DIP switch) or some type of handshaking. Further, the other registers 34 are grouped together to allow multiple controllers in a building and/or close proximity. Only the master register 300 will have its embedded web interface activated to provide a user interface. Data is passed to, and from, the other registers 34 via the master register 300. Additionally, the master register 300 functions as the central controller 32 except for the user interface on the front panel. The master register 300 requires interface with the HVAC unit to change the HVAC unit settings based on user command.

While the present invention is susceptible of embodiments in many different forms, there are shown in the drawings and herein described in detail, preferred embodiments of the invention with the understanding that this description is to be considered as an exemplification of the principles of the invention and is not intended to limit the broad aspects of the invention to the embodiments illustrated. The aforementioned example architectures above according to the present invention can be implemented in many ways, such as program instructions for execution by a processor, as logic circuits, as ASIC, as firmware, etc., as is known to those skilled in the art. Therefore, the present invention is not limited to the example embodiments described herein.

What is claimed is:

1. A control system for controlling an HVAC unit, comprising:
a central controller connected to the HVAC unit for controlling the HVAC settings, the central controller including a wireless communication interface including a first wireless transceiver for wireless communication with a display device capable of displaying a user interface for user interaction with the central controller via the user interface to control the HVAC settings.

2. The control system of claim 1 wherein the central controller further maintains a control user interface therein, and provides the control user interface device to the display device for display to the user.

3. The control system of claim 2 wherein the control user interface comprises a Web-page user interface, and the display device includes a Web browser capable of displaying the Web-page.

4. The control system of claim 2 wherein the central controller controls the HVAC unit based on user commands through the user interface.

5. The control system of claim 1 wherein the wireless communication interface comprises a wireless transceiver.

6. The control system of claim 5 wherein the wireless transceiver comprises an IEEE802.11x transceiver.

7. The control system of claim 1 further comprising one or more vent controllers, each vent controller for controlling operation of a corresponding air vent that receives air flow from the HVAC unit via an air duct.

8. The control system of claim 7 wherein:
the wireless communication interface further includes a second wireless transceiver for communication with each vent controller;
each vent controller includes a wireless transceiver for wireless data and/or command communication between the vent controller and the central controller.

9. The control system of claim 8 wherein each vent controller controls an actuator for operating a corresponding air vent based on commands from the central controller.

10. The control system of claim 9 wherein each vent controller further includes a temperature sensor for sensing the ambient temperature and communicating the sensed temperature to the central controller.

11. The control system of claim 10 wherein each vent controller further includes a power generation unit that powers the vent controller.

12. The control system of claim 11 wherein the power generation unit comprises a rechargeable energy storage unit.

13. The control system of claim 12 wherein the power generation unit further includes a power generator for supplying power to the vent controller and charging the energy storage unit.

14. The control system of claim 13 wherein the power generator in each vent controller converts air flow energy proximate the vent into electrical power.

15. A control system for controlling an HVAC unit, comprising:
a central controller connected to the HVAC unit for controlling the HVAC settings, the central controller including a wireless communication interface for wireless communication with a display device capable of displaying a user interface for user interacting with the central controller via the user interface to control the HVAC settings;
one or more vent controllers, each vent controller for controlling operation of a corresponding air vent that receives air flow from the HVAC unit via an air duct;
wherein the central controller further maintains a control user interface therein, and provides the control user interface device to the display device for display to the user.

16. The control system of claim 15 wherein the control user interface comprises a Web-page user interface, and the display device includes a Web browser capable of displaying the Web-page.

17. The control system of claim 16 wherein the central controller controls the HVAC unit based on user commands through the user interface.

18. The control system of claim 17 wherein:
the wireless communication interface of the central further provides communication with each vent controller;
each vent controller includes a wireless transceiver for wireless data and/or command communication between the vent controller and the central controller.

19. The control system of claim 18 wherein each vent controller controls an actuator for operating a corresponding air vent base on commands from the central controller.

20. The control system of claim 19 wherein each vent controller further includes a temperature sensor for sensing the ambient temperature and communicating the sensed temperature to the central controller.

21. The control system of claim 20 wherein each vent controller further includes a power generation unit that power the vent controller.

22. The control system of claim 21 wherein each power generation unit comprises a rechargeable energy storage unit.

23. The control system of claim 22 wherein each power generation unit further includes a power generator for supplying power to the vent controller and charging the energy storage unit.

24. The control system of claim 23 wherein each power generator in each vent controller converts air flow energy proximate the vent into electrical power.

25. The control system of claim 15 wherein each vent controller includes an identifier which uniquely identifies the vent controller to the central controller for command and control.

26. A control system for controlling an HVAC unit, comprising:
a master vent controller connected to the HVAC unit for controlling the HVAC settings, the master vent controller including a wireless communication interface for wireless communication with a display device capable of displaying a user interface for user interacting with the master vent controller via the user interface to control the HVAC settings, the master vent controller further controlling operation of a corresponding air vent that receives air flow from the HVAC unit via an air duct;
one or more vent controllers, each vent controller for controlling operation of a corresponding air vent that receives air flow from the HVAC unit via an air duct; and
wherein the master vent controller further maintains a control user interface therein, and provides the control user interface device to the display device for display to the user.

27. The control system of claim 26 wherein the control user interface comprises a Web-page user interface, and the display device includes a Web browser capable of displaying the Web-page.

28. The control system of claim 27 wherein the master vent controller controls the HVAC unit based on user commands through the user interface.

29. The control system of claim 28 wherein:
the wireless communication interface of the master vent further provides communication with each vent controller;
each vent controller includes a wireless transceiver for wireless data and/or command communication between the vent controller and the master vent controller.

30. The control system of claim 29 wherein:
the master vent controller controls an actuator for operating a corresponding air vent; and
each vent controller controls an actuator for operating a corresponding air vent base on commands from the master vent controller.

31. The control system of claim 30 wherein:
the master vent controller further includes a temperature sensor for sensing the ambient temperature;
each vent controller further includes a temperature sensor for sensing the ambient temperature and communicating the sensed temperature to the central controller.

32. The control system of claim 31 wherein:
the master vent controller further includes a power generation unit that powers the corresponding vent controller; and
each vent controller further includes a power generation unit that power the corresponding vent controller.

33. The control system of claim 32 wherein each power generation unit comprises a rechargeable energy storage unit.

34. The control system of claim 33 wherein each power generation unit further includes a power generator for supplying power to the vent controller and charging the energy storage unit.

35. The control system of claim 34 wherein each power generator in each vent controller converts air flow energy proximate the vent into electrical power.

36. The control system of claim 26 wherein each of the master controller and the vent controllers includes an identifier which uniquely identifies the vent controllers each other for command and control.
